(19) United States
(12) Patent Application Publication
(10) Pub. No.: US 2023/0071082 A1
(43) Pub. Date: Mar. 9, 2023

(54) IMAGE PROCESSING APPARATUS AND METHOD FOR STORING SETTING HISTORY

(71) Applicant: SHARP KABUSHIKI KAISHA, Sakai City (JP)

(72) Inventor: TAKUYA KOUJIRO, Sakai City (JP)

(21) Appl. No.: 17/896,563

(22) Filed: Aug. 26, 2022

(30) Foreign Application Priority Data
Sep. 3, 2021 (JP) 2021-143948

(51) Int. Cl. G06F 3/12

(52) U.S. Cl. CPC G06F 3/1205; G06F 3/1273; G06F 3/1278

(57) ABSTRACT

An image processing apparatus includes a job executor, a storage, and a controller. The job executor executes a job related to image processing. The storage stores therein a setting value related to the execution of the job as setting history. The controller controls the storing of the setting value into the storage. The controller restricts the setting value from being stored if the setting value meets definition of a specific setting value.

### BACKGROUND OF THE INVENTION

### Field of the Invention

The present disclosure relates to an image processing apparatus and the like.

### Description of the Background Art

Some image processing apparatuses, such as multifunction peripherals, store setting values related to execution of a job, such as printing, faxing, or image transmission, as setting history.

In recent years, attempts have been made to reduce a user's time and effort involved in job execution through the use of stored setting history. Specifically, an image processing apparatus displays setting history on a display to allow for a user's selection. The image processing apparatus receives the user's selection of history information from the setting history and executes a job based on setting values associated with the history information selected from the setting history. Thus, the image processing apparatus can easily reproduce the job corresponding to the history information selected from the setting history.

Generally, the setting history contains setting values for all setting items related to job execution. However, it is undesirable from a security perspective to store, for example, history information including confidential information, such as a password for accessing access-controlled information, as setting history. Furthermore, history information including a reading object document-dependent setting item, a file name setting, or the like, if stored as setting history, cannot be reused as is; it is necessary to manually change a setting (setting value) in the history information before use, which is burdensome.

As a conventional technology for controlling the storing of setting history, for example, an image input/output device is disclosed that allows for selection of a history information storing method according to an attribute of each job.

According to the conventional technology, history information of a job is not stored if the job is of type that meets definition of secure setting item-involving job, such as a job for printing image data stored in a removable external storage medium or a job related to secure printing.

In the case of the job of above-described job type, therefore, the conventional technology makes it impossible to reuse even setting items other than the secure setting item in history information of the job. That is, the configuration of the conventional technology is not user-friendly for a user who wishes to reuse the history information of such a job.

Furthermore, the conventional technology does not give consideration to controlling the storing of, as setting history, history information including a setting item that is not reusable as is. That is to say, the conventional technology does not sufficiently control the storing of setting history for all jobs involving setting items forming history information that, should not be stored (history information that, is not reusable even if stored), such as jobs involving a secure setting item or jobs involving a reading object document-dependent setting item.

An objective of the present disclosure is to provide an image processing apparatus and the like that makes it possible to read only settings of reusable setting items when reusing, as setting history, history information of a job involving setting items forming history information that should not be stored, and to further improve the convenience of the use of history information.

### SUMMARY OF THE INVENTION

In order to achieve the above-described objective, the present disclosure provides an image processing apparatus including: a job executor that executes a job related to image processing; a storage that stores therein a setting value related to the execution of the job as setting history; and a controller that controls the storing of the setting value into the storage, wherein the controller restricts the setting value from being stored if the setting value meets definition of a specific setting value.

The present disclosure also provides a method for storing setting history, the method including: executing a job related to image processing; storing a setting value related to the execution of the job as setting history; and controlling the storing of the setting value in the storing, wherein in the controlling, the setting value is restricted from being stored if the setting value meets definition of a specific setting value.

According to the present disclosure, it is possible to provide an image processing apparatus and the like that makes it possible to read only settings of reusable setting items when reusing, as setting history, history information of a job involving setting items forming history information that should not be stored, and to further improve the convenience of the use of history information.

### BRIEF DESCRIPTION OF THE DRAWINGS

FIG. 1 is an external perspective view of a multifunction peripheral according to a first embodiment.

FIG. 2 is a functional configuration diagram of the multifunction peripheral according to the first embodiment.

FIG. 3 is a diagram for explaining a specific setting value according to the first embodiment and jobs that involve the use of the specific setting value.

FIG. 4A is a diagram illustrating a configuration example of a data structure of setting history.

FIG. 4B is a diagram illustrating a configuration example of a data structure of a setting value file.

FIG. 5 is a diagram illustrating a configuration example of a data structure of job history.

FIG. 6 is a flowchart for explaining a flow of processing according to the first embodiment.

FIG. 7 is a flowchart for explaining a flow of processing according to the first embodiment.

FIG. 8 is a diagram illustrating an operation example according to the first embodiment.

FIGS. 9A and 9B are diagrams each illustrating an operation example according to the first embodiment.

FIG. 10 is a diagram for explaining specific setting values according Example 1 of a second embodiment and jobs that involve the use of the specific setting values,

FIG. 11 is a flowchart for explaining a flow of processing according to Example 1 of the second embodiment.

FIGS. 12A and 12B are diagrams each illustrating an operation example according to Example 1 of the second embodiment.

FIG. 13 is a diagram for explaining specific setting values according to Example 2 of the second embodiment and jobs that involve the use of the specific setting values.

FIG. 14 is a flowchart for explaining a flow of processing according to Example 2 of the second embodiment.

FIG. 15 is a diagram illustrating an operation example according to Example 2 of the second embodiment.

FIGS. 16A and 16B are diagrams each illustrating an operation example according to Example 2 of the second embodiment.

FIG. 17 is a functional configuration diagram of a multifunction peripheral according to a third embodiment.

FIGS. 18A and 18B are diagrams each illustrating an operation example according to the third embodiment.

### DESCRIPTION OF THE PREFERRED EMBODIMENTS

The following describes embodiments of the present disclosure with reference to the accompanying drawings. In the present disclosure, a multifunction peripheral capable of performing jobs related to, for example, copying, faxing, and image transmission in a single housing will be described as one form of an image processing apparatus. Note that the embodiments described below are examples for explaining the present disclosure, and the technical scope of the description set forth in the claims is not limited to the following description.

The term “job execution” or “execution of a job” as used herein means a series of processes that are performed for a job under the control in any of, for example, copy, fax, and image transmission job modes, from reading setting history or inputting setting values to finishing the operation of the job started in response to input of a job execution instruction.

The term “specific setting value(s)” as used in the present disclosure refers to a concept including not only a specific setting but also a value thereof, and the specific setting refers to a setting determined based on operational conditions of a multifunction peripheral such as device settings (including initial settings), a function, and a job mode, or settings made by a user. As a general rule, the term “to meet definition of” is used in the present disclosure if information (value) set as a setting value partially or completely satisfies definition of a specific setting value in terms of concept. A setting value “that meets definition of” a specific setting value in the present disclosure means a setting value to be restricted from being stored as setting history.

### 1. First Embodiment

In a first embodiment, a specific setting value is a security-related setting value, and the security-related setting value includes an identification code for accessing access-controlled information.

1.1. Functional Configuration

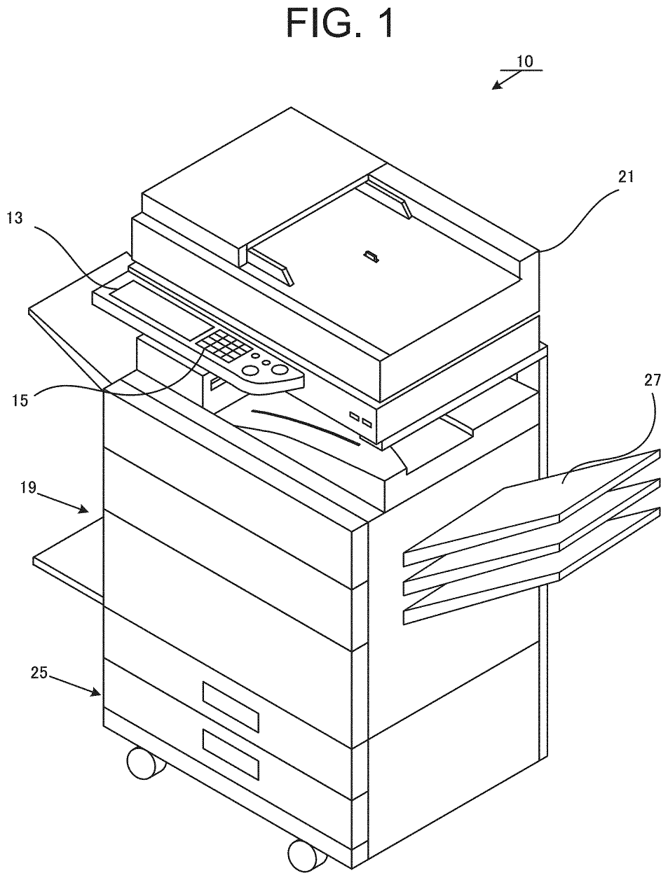

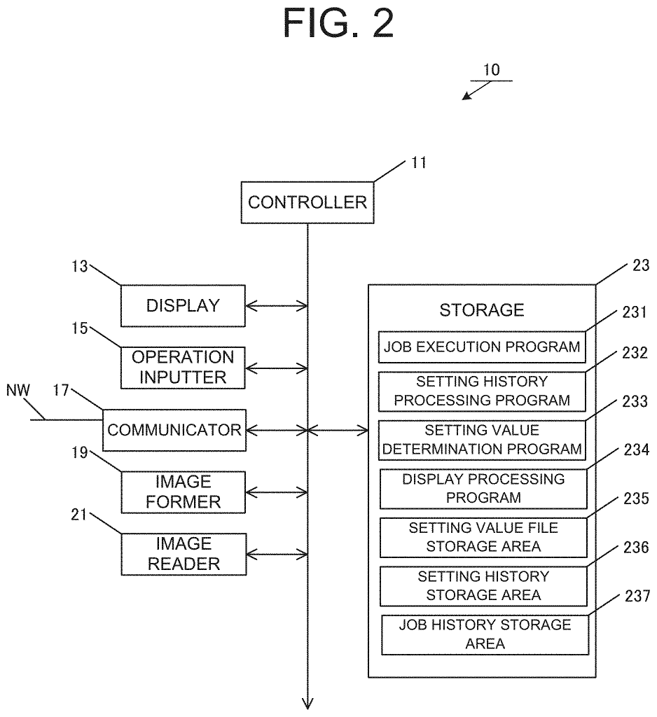

A functional configuration of a multifunction peripheral 10 according to the first embodiment will be described with reference to FIGS. 1 and 2. FIG. 1 is an external perspective view schematically illustrating an overall configuration of the multifunction peripheral 10. FIG. 2 is a functional configuration diagram of the multifunction peripheral 10. The multifunction peripheral 10 includes a controller 11, a display 13, an operation inputter 15, a communicator 17, an image former 19, an image reader 21, and a storage 23.

The controller 11 performs overall control of the multifunction peripheral 10. The controller 11 includes, for example, one or more computing devices (for example, central processing unit: CPU). The controller 11 reads and executes various programs stored in the storage 23, thereby implementing functions thereof.

The display 13 displays various information to, for example, a user. The display 13 may include, for example, a liquid crystal display (LCD) or an organic electro-luminescence (EL) display.

The operation inputter 15 receives input of information by the user, for example. The operation inputter 15 may include, for example, hard keys (for example, numeric keypad) and buttons. The operation inputter 15 can be configured as a touch panel that allows input via the display 13. In this case, for example, a common method such as a resistive method, an infrared method, an inductive method, or a capacitive method may be employed as an input method for the touch panel.

The communicator 17 includes, for example, either or both of a wired interface and a wireless interface for communication with other devices via a network (NW) such as a local area network (LAN), a wide area network (WAN), the Internet, a telephone line, or a fax line.

The image former 19 forms an image based on image data on paper, which is a recording medium. The image former 19 feeds paper from a paper feeder 25, forms an image based on the image data on the paper, and then discharges the paper to a paper discharger 27. The image former 19 may include, for example, a laser printer adopting an electrophotographic method. In this case, the image former 19 forms images using toners supplied from toner cartridges, not shown, corresponding to respective toner colors (for example, cyan, magenta, yellow, and black).

The image reader 21 generates image data by scanning and reading a document image. The image reader 21 may be, for example, configured as a scanner device having an image sensor such as a charge coupled device (CCD) or a contact image sensor (CIS). No limitations are placed on the configuration of the image reader 21 as long as the image reader 21 is configured to generate image data by reading a reflected light image resulting from a document image using an image sensor.

The storage 23 stores therein various types of data and various types of programs necessary for operation of the multifunction peripheral 10. The storage 23 may include, for example, a storage device such as random access memory (RAM), a hard disk drive (HDD), a solid state drive (SSD), or read only memory (ROM).

In the first embodiment, the storage 23 stores therein a job execution program 231, a setting history processing program 232, a setting value determination program 233, and a display processing program 234. In the storage 23, a setting value file storage area 235, a setting history storage area 236, and a job history storage area 237 are reserved.

The controller 11 reads the job execution program 231 for performing processing accompanying the execution of various functions, such as copy, fax, and image data transmission functions, on a job-by-job basis. The controller 11 that has read the job execution program 231 executes the job by controlling, for example, the display 13, the operation inputter 15, the communicator 17, the image former 19, and the image reader 21, which function as job executors. The controller 11 that has read the job execution program 231 can read setting history and execute various jobs based on setting values contained in setting value files in the setting history.

The controller 11 reads the setting history processing program 232 when, for example, acquiring setting values related to job execution, generating setting history, and performing various types of processing on the setting history. The controller 11 that has read the setting history processing program 232 acquires setting values related to job execution and generates a setting value file containing the setting values. The controller 11 then stores the generated setting value file in the setting value file storage area 235. The controller 11 also generates setting history by associating the setting value file with identification information (for example, job ID) for identifying which job the setting value file is related to. The controller 11 then stores the generated setting history in the setting history storage area 236.

The controller 11 reads the setting value determination program 233 when executing a job and generating setting history related to the job. The controller 11 that has read the setting value determination program 233 functions as a determiner that, after the execution of the job, scans each of setting values related to the execution of the job and determines whether or not the setting value meets the definition of the specific setting value. Upon determining that a setting value meets the definition of the specific setting value, the controller 11 controls the storing of the setting value. That is, the controller 11 performs a control to restrict the setting value that meets the definition of the specific setting value from being stored in the setting value file.

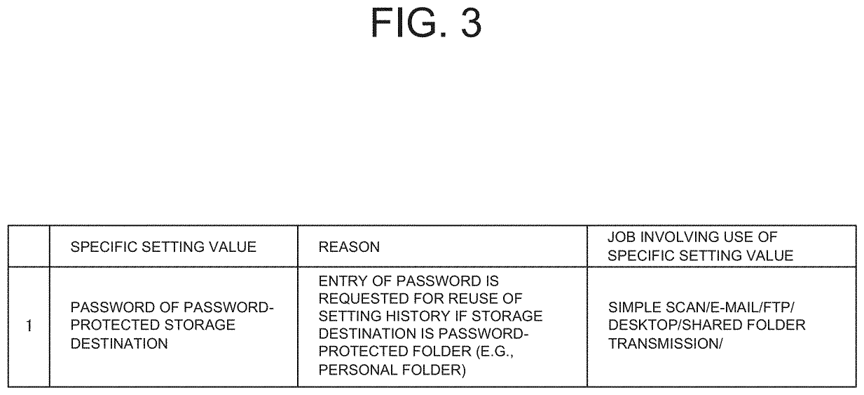

In the first embodiment, the specific setting value is a security-related setting value, and the security-related setting value is an identification code for accessing access-controlled information. FIG. 3 is a diagram for explaining the reason why an identification code (password) for accessing access-controlled information is defined as the specific setting value and explaining jobs that involve the use of the specific setting value. In a case where a user saves data in a password-protected folder (for example, confidential folder), the user is prompted to enter a password when reusing the setting history. In the first embodiment, therefore, a password serving as an identification code is handled as the specific setting value in consideration of security and user convenience.

Examples of jobs that involve the use of the specific setting value include jobs related to scan save functions and filing functions such as simple scan, e-mail, image data upload to FTP server, file server transmission scan (referred to simply as FTP), image data processing with specific application software, desktop transmission scan (referred to simply as desktop), image data transmission to shared folder, shared folder transmission scan (referred to simply as shared folder transmission).

Returning to FIG. 2, the controller 11 reads the display processing program 234 when displaying a predetermined display screen on the display 13. Examples of predetermined display screens include: a display screen that displays a list of the setting history; setting screens that receive input of, for example, various setting values related to job execution, an execution instruction, and a termination instruction; a basic screen for displaying the setting screens in a switchable manner; and a login screen for user authentication.

In the setting value file storage area 235, the setting value file generated by the controller 11 that has read the setting history processing program 232 is stored. Setting values include those that are determined based on operational conditions of the multifunction peripheral such as device settings (including initial settings), a function, a job mode, or settings made by the user. The controller 11 that has read the job execution program 231 can reproduce the job by acquiring the setting value file associated with history information in the setting history from the setting value file storage area 235 and executing the job based on setting values contained in the setting value file.

In the setting history storage area 236, the setting history generated by the controller 11 that has read the setting history processing program 232 is stored. The setting history stored in the setting history storage area 236 is read as needed for a list displaying processing or job execution based on the setting history.

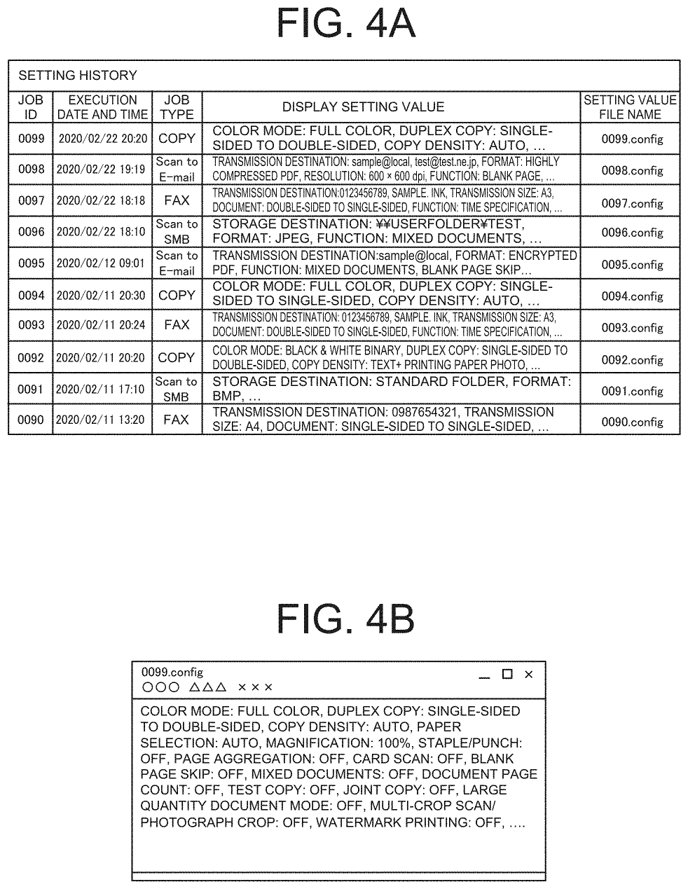

The following describes the setting history and the setting value file according to the present disclosure. FIG. 4A is a diagram illustrating a configuration example of a data structure of the setting history stored in the setting history storage area 236. FIG. 4B is a diagram illustrating a configuration example of a data structure of a setting value file stored in the setting value file storage area 235.

The setting history shown as an example in FIG. 4A includes job ID, execution date and time, job type, display setting value, and setting value file name.

The job ID is identification information for identifying which job each item of history information in the setting history relates to. The execution date and time indicates the date and time of the execution of each job. The job type indicates the type of each executed job (examples thereof include copy job, fax job, and image transmission job such as Scan to E-mail). The display setting value indicates some of the setting values (set information) to be displayed on the display screen that displays a list of the setting history. The setting value file name indicates a file name of the setting value file associated with each item of history information in the setting history.

For example, the history information related to job ID “0099” in the setting history indicates history information about a job having a job type of “copy” and executed on “2020/02/22 20:20”. This job is a copy job executed based on setting values contained in the setting value file named “0099.config”. In this example, setting values such as “color mode: full color, duplex copy: single-sided to double-sided, copy density: auto, . . . ” are set as display setting values. Note that the display setting values set for each job ID in FIG. 4A are merely examples, and the setting values to be displayed on the display screen are not limited to those shown in FIG. 4A.

FIG. 4B is a diagram illustrating a configuration example of a data structure of the setting value file “0099.config” associated with job ID “0099” in FIG. 4A.

Each setting value file can be configured, for example, as a text file containing setting values corresponding to respective settings. For example, the example shown in FIG. 4B is a setting value file related to a copy job and contains setting values for the execution of the copy job (for example, color mode: full color, duplex copy: single-sided to double-sided, copy density: auto, . . . ). Upon determining that a setting value meets the definition of the specific setting value, the controller 11 generates a setting value file by applying thereto a storage restriction for the setting value. In a case where history information associated with this setting value file is read from the setting history for reuse purpose, therefore, the user can readily input and set a setting value with respect to the specific setting value without manually changing the setting value. In the first embodiment, the specific setting value is a security-related setting value, and thus such a setting value is not displayed to the user executing the job. This prevents leakage of an identification code such as a password to the user executing the job.

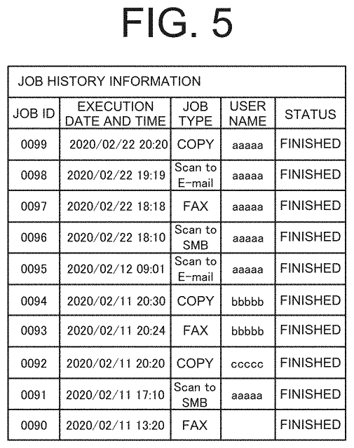

Returning to FIG. 2, a record of executed jobs is stored as job history in the job history storage area 237. The following describes the job history according to the present disclosure. FIG. 5 is a diagram illustrating a configuration example of a data structure of the job history stored in the job history storage area 237.

The job history shown as an example in FIG. 5 includes job ID, execution date and time, job type, user name, and status.

The job ID, the execution date and time, and the job type are the same items and indicate the same information as the items included in the setting history described with reference to FIG. 4A. The user name indicates the name of a user who executed each job. The status indicates the processing status of each job.

For example, history information related to job ID “0098” in the job history indicates history information about a job having a job type of “Scan to E-mail” and executed on “2020/02/22 19:19”. The history information indicates that a user having a user name “aaaaa” inputted an execution instruction for the job, and the status of the job is “finished”.

Unlike the setting history, the job history is information accumulated by recording job execution history, and can therefore be generated at any time, such as after a job is entered, after a job is completed, or after the setting history is generated.

1.2. Flow of Processing

### 1.2.1. Flow of Overall Processing

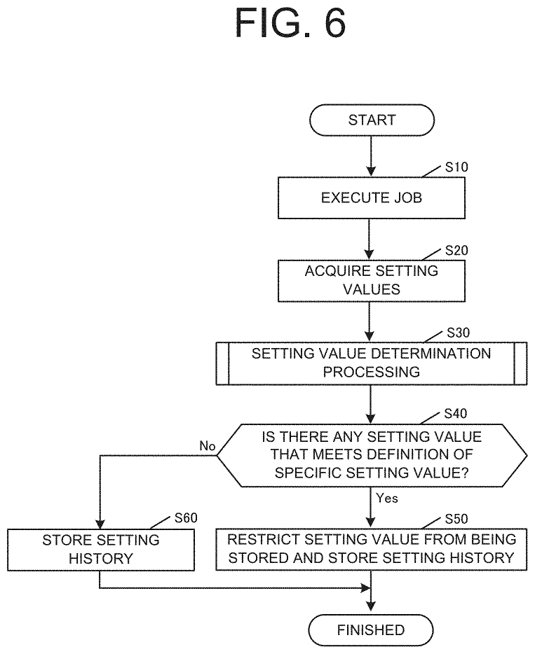

Next, a flow of processing according to the first embodiment will be described. FIG. 6 is a flowchart for explaining overall processing to be performed by the multifunction peripheral 10. The processing described below is performed through the controller 11 reading the job execution program 231, the setting history processing program 232, the setting value determination program 233, and the display processing program 234.

After a job has been executed, the controller 11 acquires setting values related to the executed job (Step S10→Step S20).

Next, the controller 11 performs setting value determination processing for the acquired setting values (Step S30).

The controller 11 determines whether or not there is any setting value that meets the definition of the specific setting value, as a result of the setting value determination processing (Step S40).

Upon determining that there is a setting value that meets the definition of the specific setting value, the controller 11 restricts this setting value from being stored, stores resulting history information as the setting history, and ends the processing (Yes in Step S40→Step S50). Specifically, the controller 11 stores, as a setting value file, the setting values other than the setting value that meets the definition of the specific setting value. The controller 11 then generates history information by associating the setting value file with the job ID of the executed job, and stores the history information as the setting history in the setting history storage area 236.

Upon determining that there is not any setting value that meets the definition of the specific setting value, the controller 11 stores resulting history information as the setting history without applying a storage restriction for the setting values and ends the processing (No in Step S40→Step S60). Specifically, the controller 11 stores all the setting values as a setting value file. The controller 11 then generates history information by associating the setting value file with the job ID of the executed job, and stores the history information as the setting history in the setting history storage area 236.

When storing, as the setting history, the history information with a storage restriction for the specific setting value in Step S50, for example, the controller 11 excludes the specific setting value from the acquired setting values. The controller 11 then collectively stores the setting values that have not been excluded (unrestricted setting values) as the setting history in the setting history storage area 236.

The controller 11 may determine whether or not the setting values are the specific setting value one setting value at a time. The controller 11 then restricts a setting value that meets the definition of the specific setting value, if any, from being stored and stores the other setting values in the setting history storage area 236.

The controller 11 may perform a control to delete the specific setting value after all the setting values have been stored in the setting history storage area 236.

That is, the setting values other than the specific setting value among the setting values acquired by the controller 11 are stored in the setting history storage area 236.

1.2.2. Flow of Setting Value Determination Processing

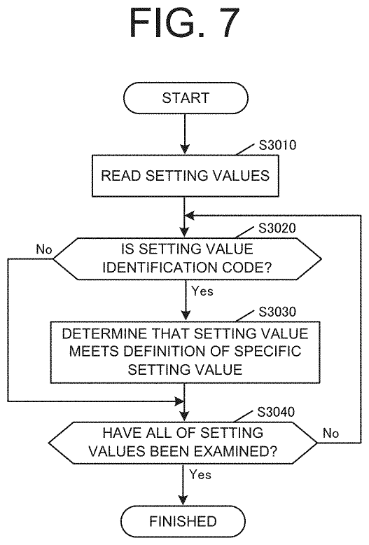

Next, the setting value determination processing in Step S30 in FIG. 6 will be described using a flowchart in FIG. 7. Note that the processing in FIG. 7 is performed through the controller 11 reading and executing the setting value determination program 233.

The controller 11 reads the setting values related to the executed job that have been acquired in Step S20 in FIG. 6 (Step S3010).

The controller 11 determines, for each of the read setting values, whether or not the read setting value is an identification code (password), which is the specific setting value (Step S3020).

If the read setting value is an identification code, the controller 11 determines that the setting value meets the definition of the specific setting value (Yes in Step S3020→Step S3030).

Next, the controller 11 determines whether or not all of the setting values have been examined (Step S3040). If all of the setting values have been examined, the controller 11 ends the processing (Yes in Step S3040→“End”). If not all of the setting values have been examined, the controller 11 returns the processing to Step S3020.

If the read setting value is not an identification code, the controller 11 causes the processing to continue to Step S3040 (No in Step S3020→Step S3040).

1.3. Operation Example

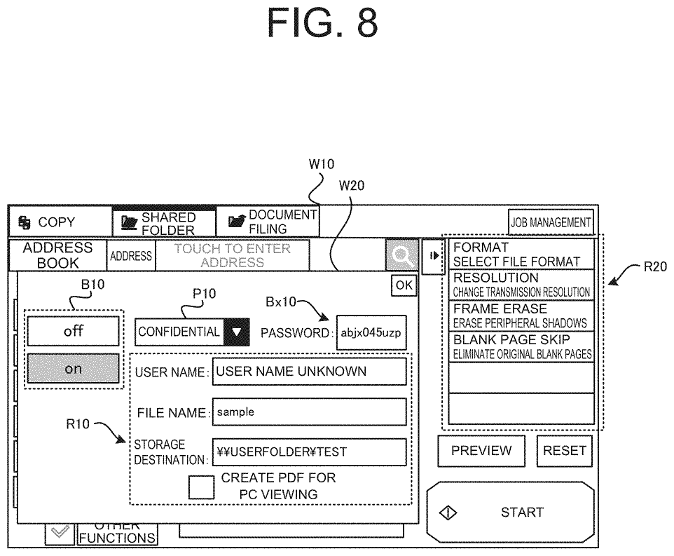

Next, an operation example according to the first embodiment will be described. FIG. 8 is a diagram illustrating a configuration example of a job setting screen W10 related to a shared folder transmission job shown as an example in FIG. 3.

The job setting screen W10 includes a function selection area R20 and a storage detail setting screen W20 that receives detailed settings for storing image data.

The function selection area R20 is a display area for displaying function selection keys that receive a selection of a function settable for job execution. The controller 11 generates a setting value file as follows. The controller 11 stores, in a setting value file, a function (setting) set through one of the function selection keys together with setting values entered through the storage detail setting screen W20.

The storage detail setting screen W20 includes on/off buttons B10, a folder type selection pull-down menu P10, a password entry box Bx10, and a user information setting area R10.

The on/off buttons B10 are input buttons that receive enable/disable settings for a storage detail setting function. The folder type selection pull-down menu P10 receives a selection of a folder type as a storage destination in which image data is to be stored. FIG. 8 shows an example in which “confidential” is selected as the storage destination folder type. The password entry box Bx10 receives input of a password for accessing the selected storage destination folder. The user information setting area R10 is a display area for displaying entry boxes that receive input of, for example, a user name, a file name, and a storage destination. Note that in the example shown in FIG. 8, the storage destination is set to ¥¥USERFOLDER¥TEST, but the storage destination may be automatically set to a standard folder, which is a system setting value, when no specific folder is specified as the storage destination.

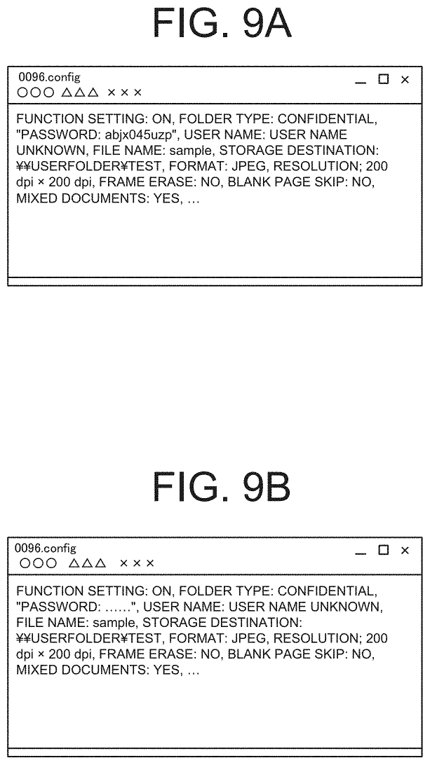

In a general case, when a shared folder transmission job is executed, a password value “abjx045uzp” entered in the password entry box Bx10 through the execution of the job is stored as a setting value in a setting value file as shown in the example in FIG. 9A. By contrast, in the case of the first embodiment, the password is a setting value that meets the definition of the specific setting value. The controller 11 therefore refrains from storing the password value “abjx045uzp” and stores the setting values other than the password in the setting value file, generating the setting value file as shown in the example in FIG. 9B.

As described above, according to the first embodiment, the specific setting value is a security-related setting value including an identification code for accessing access-controlled information. Since the first embodiment has a configuration in which the storing of setting values is partially restricted when the setting values include such a specific setting value, an image processing apparatus and the like can be provided that makes it possible to ensure security, to reduce the burden of manually changing a setting, and to further improve the convenience of the use of history information, when setting history is reused.

### 2. Second Embodiment

According to a second embodiment, the specific setting value is a job operation-related setting value, and the job-operation related setting value includes a setting value that is not reusable for job execution.

2.1. Functional Configuration

A multifunction peripheral according to the second embodiment may have the same functional configuration as the multifunction peripheral 10 according to the first embodiment. Therefore, the description of the functional configuration of the multifunction peripheral according to the second embodiment is omitted, and the second embodiment is described using the same reference signs as the multifunction peripheral 10 according to the first embodiment.

2.2. Example 1

The following describes Example 1 of the second embodiment in which the setting value that is not reusable for job execution includes a preview image edit-related setting value or an interrupt job-related setting value.

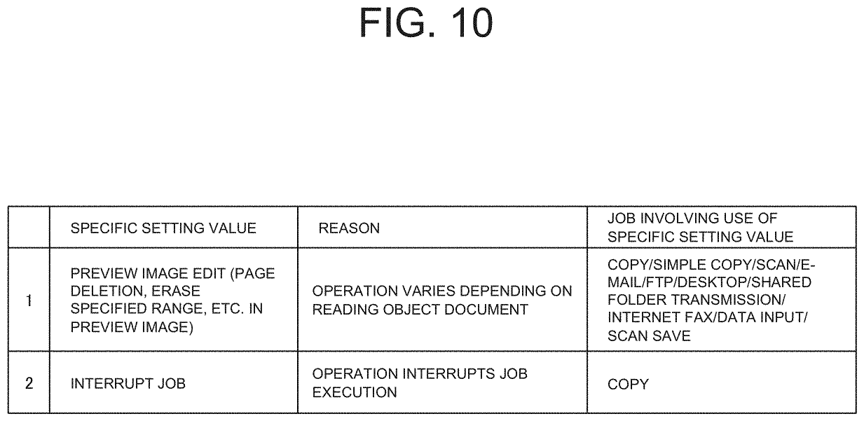

FIG. 10 is a diagram for explaining the reason why a preview image edit-related setting value or an interrupt job-related setting value is defined as the specific setting value and explaining jobs that involve the use of such specific setting values. Preview image edit, which includes an operation such as page deletion or specified range erasing in a preview image, varies depending on reading object document. An interrupt job refers to an operation that interrupts job execution. When a user wishes to execute a job by reading and reproducing history information of preview image edit or an interrupt job from the setting history, such history information cannot be reflected in the execution of the job. In Example 1 of the second embodiment, therefore, setting values related to such jobs are handled as specific setting values in consideration of reducing the burden of manually changing a setting and further improving the convenience of the use of history information when the setting history is reused.

Examples of preview image edit-related jobs that involve the use of such specific setting values include copy, easy copy, scan, e-mail, FTP, desktop, shared folder transmission, Internet FAX, data input, and scan save. Examples of interrupt jobs that involve the use of such specific setting values include copy.

2.2.1. Flow of Processing

### 2.2.1.1. Flow of Overall Processing

Overall processing according to Example 1 may be the same as the overall processing described with reference to FIG. 6. The description thereof is therefore omitted here.

2.2.1.2. Flow of Setting Value Determination Processing

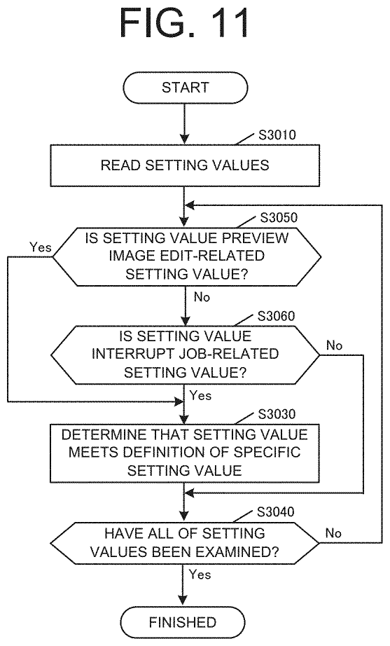

Next, the setting value determination processing in Step S30 in FIG. 6 will be described using a flowchart in FIG. 11. Note that the same step number as in FIG. 7 is used for the same processing as that described with reference to FIG. 7.

The controller 11 reads the setting values related to the executed job that have been acquired in Step S20 in FIG. 6 (Step S3010).

The controller 11 determines, for each of the read setting values, whether or not the read setting value is a preview image edit-related setting value, which is the specific setting value (Step S3050).

If the read setting value is a preview image edit-related setting value, the controller 11 determines that the setting value meets the definition of the specific setting value (Yes in Step S3050→Step S3030).

If the read setting value is not a preview image edit-related setting value, the controller 11 determines whether or not the read setting value is an interrupt job-related setting value, which is the specific setting value (No in Step S3050→Step S3060).

If the read setting value is an interrupt job-related setting value, the controller 11 determines that the setting value meets the definition of the specific setting value (Yes in Step S3060→Step S3030). If the read setting value is not an interrupt job-related setting value, the controller 11 causes the processing to continue to Step S3040 (No in Step S3060→Step S3040).

Next, the controller 11 determines whether or not all of the setting values have been examined (Step S3040). If all of the setting values have been examined, the controller 11 ends the processing (Yes in Step S3040→“End”). If not all of the setting values have been examined, the controller 11 returns the processing to Step S3050.

2.2.2. Operation Example

Next, an operation example according to Example 1 will be described. The following describes, as an example of operation according to Example 1, an operation example in which the setting value that is not reusable for job execution includes a preview image edit-related setting value.

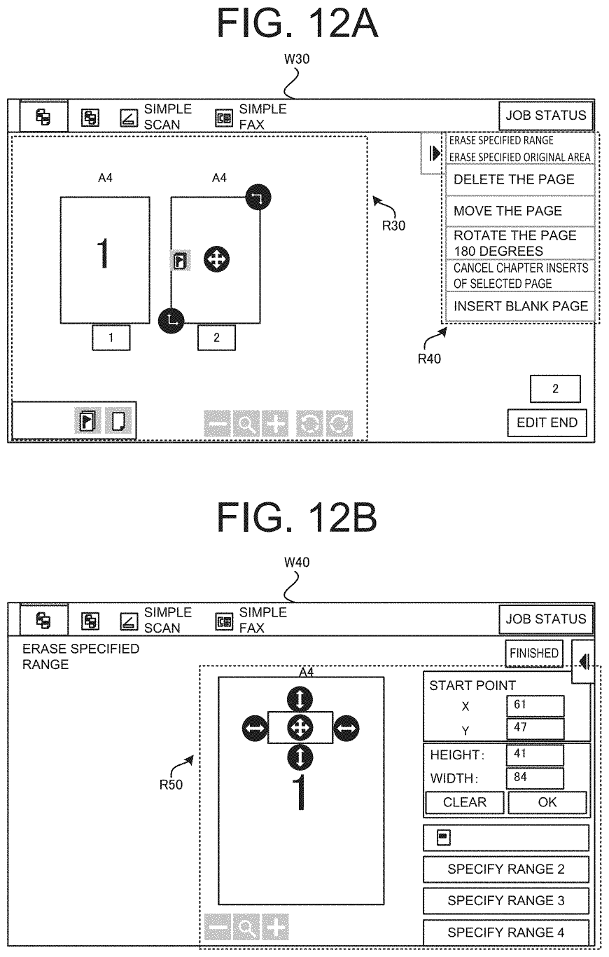

FIG. 12A is a diagram illustrating a configuration example of a preview image edit screen W30. FIG. 12B is a diagram illustrating a configuration of an erase specified range screen W40.

The preview image edit screen W30 includes a preview image edit area R30 and a function selection area R40. The preview image edit area R30 displays, for example, various operation buttons that receive preview image edit, such as page rotation or page deletion. The function selection area R40 is a display area for displaying function selection keys that receive a selection of a function settable for preview image edit to be executed as a job. The function selection keys include an “erase specified range” key as a trigger to display the erase specified range screen W40 shown as an example in FIG. 12B. The user can display the erase specified range screen W40 by pressing the “erase specified range” key.

The erase specified range screen W40 includes an erasing range specifying area R50. The erasing range specifying area R50 is a display area for displaying, for example, setting buttons that receive input of erasing settings for erasing a specified area from a preview image (document image), starting point coordinates of an erasing start point, and height and width information of an erasing range.

The user can edit the preview image through the preview image edit screen W30 and the erase specified range screen W40. In this case, the controller 11 determines that a preview image edit-related setting value meets the definition of the specific setting value through the preview image edit screen W30 and the erase specified range screen W40. The controller 11 performs a control to restrict this preview image edit-related setting value from being stored in a setting value file.

2.3. Example 2

The following describes Example 2 of the second embodiment in which the setting value that is not reusable for job execution includes a setting value related to paper selection, unauthorized printing prevention, developer saving, automatic file name generation, document reading, external storage device file path, or digital signature or encryption.

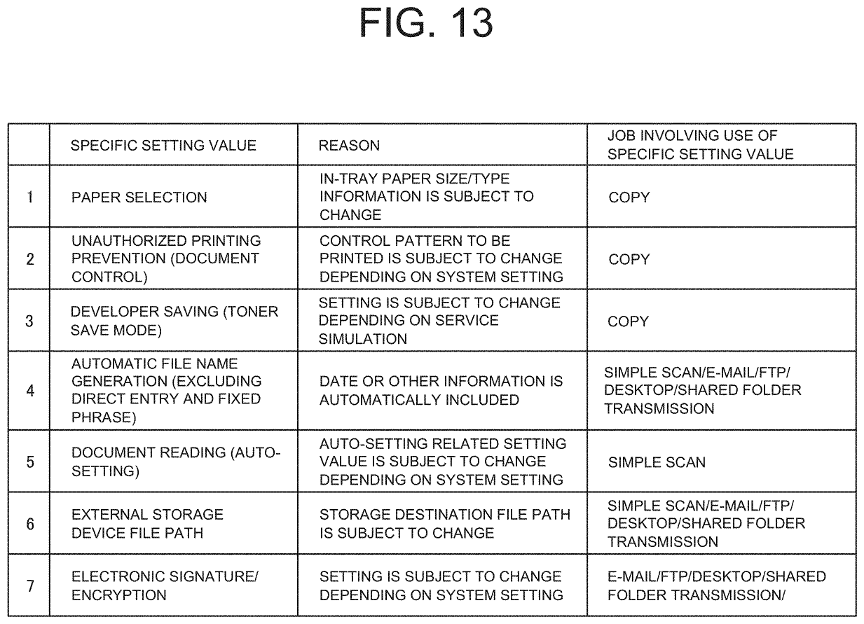

FIG. 13 is a diagram for explaining the reason why a setting value related to paper selection, unauthorized printing prevention, developer saving, automatic file name generation, document reading, external storage device file path, or electronic signature or encryption is defined as the specific setting value and explaining jobs that involve the use of such specific setting values. The following individually describes such setting values.

(1) Paper Selection-Related Setting Value

A paper selection-related setting value refers to a copy job-related setting value such as paper size, paper type, or number of sheets to be printed on. The paper selection-related setting value, such as in-tray paper size/type information or number of sheets to be printed on may be changed each time a copy job is executed. The paper selection-related setting value is therefore handled as the specific setting value in Example 2.

(2) Unauthorized Printing Prevention-Related Setting Value

An unauthorized printing prevention-related setting value refers to a setting value related to a copy job including a document control function. The document control function refers to a function of preventing unauthorized printing such as secondary copying of an important document by embedding and printing a document control pattern on the document, and stopping a reading operation of the document when the document is read using a device having the document control function. The document control pattern to be printed is subject to change depending on system setting. The unauthorized printing prevention-related setting value is therefore handled as the specific setting value in Example 2.

(3) Developer Saving-Related Setting Value

A developer saving-related setting value refers to a setting value related to a copy job using a developer (toner) for printing (image formation). The developer saving-related setting value is subject to change depending on service simulation. The developer saving-related setting value is therefore handled as the specific setting value in Example 2.

(4) Automatic File Name Generation-Related Setting Value

An automatic file name generation-related setting value refers to a setting value related to a job including a function of automatically assigning a file name to image data generated through, for example, document reading, such as simple scan, e-mail, FTP, desktop, or shared folder transmission. In the case of the automatic file name generation-related setting value, a date or other information may be automatically included in a file name. The automatic file name generation-related setting value is therefore handled as the specific setting value in Example 2.

(5) Document Reading-Related Setting Value

A document reading-related setting value refers to a setting value related to a simple scan job including an auto-setting function. The auto-setting function refers to a function of skipping blank pages, determining document top and bottom, or detecting and automatically correcting misalignment such as document skew in document reading. The auto-setting related setting value is subject to change depending on system setting. The document reading-related setting value is therefore handled as the specific setting value in Example 2.

(6) External Storage Device File Path-Related Setting Value

An external storage device file path-related setting value refers to a setting value related to a job that allows setting of a file path to an external storage device in which image data generated through, for example, document reading is to be stored, such as simple scan, e-mail, FTP, desktop, or shared folder transmission. The external storage device file path-related setting value is subject to change depending on storage destination. The external storage device file path-related setting value is therefore handled as the specific setting value in Example 2.

(7) Digital Signature or Encryption-Related Setting Value

A digital signature or encryption-related setting value refers to a setting value related to a job including a function of adding a digital signature to image data generated through, for example, document reacting or encrypting the image data, such as e-mail, FTP, desktop, or shared folder transmission. The digital signature or encryption-related setting value is subject to change depending on, for example, system setting. The digital signature or encryption-related setting value is therefore handled as the specific setting value in Example 2.

The specific setting value according to Example 2 is a setting value that is likely to be changed through, for example, job setting, service simulation, or system setting. In Example 2, as in the case of Example 1, setting values related to such jobs are handled as the specific setting value in consideration of reducing the burden of manually changing a setting and further improving the convenience of the use of history information when the setting history is reused. Note that FIG. 13 is merely an example, and the specific setting value is not limited to what is described with reference to FIG. 13.

2.3.1. Flow of Processing

### 2.3.1.1. Flow of Overall Processing

Overall processing according to Example 2 may be the same as the overall processing described with reference to FIG. 6. The description thereof is therefore omitted here.

2.3.1.2. Flow of Setting Value Determination Processing

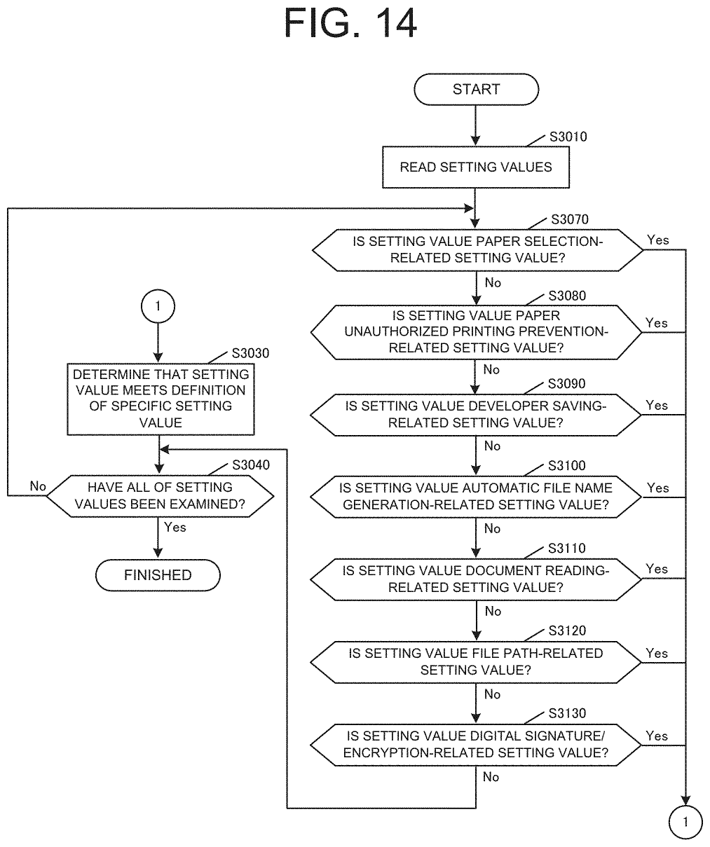

Next, the setting value determination processing in Step S30 in FIG. 6 will be described using a flowchart in FIG. 14. Note that the same step number as in FIG. 7 is used for the same processing as that described with reference to FIG. 7.

The controller 11 reads the setting values related to the executed job that have been acquired in Step S20 in FIG. 6 (Step S3010).

The controller 11 determines, for each of the read setting values, whether or not the read setting value is a paper selection-related setting value, which is the specific setting value (Step S3070).

If the read setting value is a paper selection-related setting value, the controller 11 determines that the setting value meets the definition of the specific setting value (Yes in Step S3070→Step S3030).

If the read setting value is not a paper selection-related setting value, the controller 11 determines whether or not the read setting value is an unauthorized printing prevention-related setting value, which is the specific setting value (No in Step S3070→Step S3080).

If the read setting value is an unauthorized printing prevention-related setting value, the controller 11 determines that the setting value meets the definition of the specific setting value (Yes in Step S3080→Step S3030).

If the read setting value is not an unauthorized printing prevention-related setting value, the controller 11 determines whether or not the read setting value is a developer saving-related setting value, which is the specific setting value (No in Step S3080→Step S3090).

If the read setting value is a developer saving-related setting value, the controller 11 determines that the setting value meets the definition of the specific setting value (Yes in Step S3090→Step S3030).

If the read setting value is not a developer saving-related setting value, the controller 11 determines whether or not the read setting value is an automatic file name generation-related setting value, which is the specific setting value (No in Step S3090→Step S3100).

If the read setting value is an automatic file name generation-related setting value, the controller 11 determines that the setting value meets the definition of the specific setting value (Yes in Step S3100→Step S3030).

If the read setting value is not an automatic file name generation-related setting value, the controller 11 determines whether or not the read setting value is a document reading-related setting value, which is the specific setting value (No in Step S3100→Step S3110).

If the read setting value is a document reading-related setting value, the controller 11 determines that the setting value meets the definition of the specific setting value (Yes in Step S3110→Step S3030).

If the read setting value is not a document reading-related setting value, the controller 11 determines whether or not the read setting value is a file path-related setting value, which is the specific setting value (No in Step S3110→Step S3120).

If the read setting value is a file path-related setting value, the controller 11 determines that the setting value meets the definition of the specific setting value (Yes in Step S3120→Step S3030).

If the read setting value is not a file path-related setting value, the controller 11 determines whether or not the read setting value is a digital signature/encryption-related setting value, which is the specific setting value (No in Step S3120→Step S3130).

If the read setting value is a digital signature/encryption-related setting value, the controller 11 determines that the setting value meets the definition of the specific setting value (Yes in Step S3130→Step S3030).

If the read setting value is not a digital signature/encryption-related setting value, the controller 11 causes the processing to continue to Step S3040 (No in Step S3130→Step S3040).

Next, the controller 11 determines whether or not all of the setting values have been examined (Step S3040). If all of the setting values have been examined, the controller 11 ends the processing (Yes in Step S3040→“End”). If not all of the setting values have been examined, the controller 11 returns the processing to Step S3070.

### 2.3.2. Operation Example

Next, an operation example according to Example 2 will be described. The following describes, as an example of operation according to Example 2, an operation example in which the setting value that is not reusable for job execution includes an external storage device file path-related setting value or an automatic file name generation-related setting value.

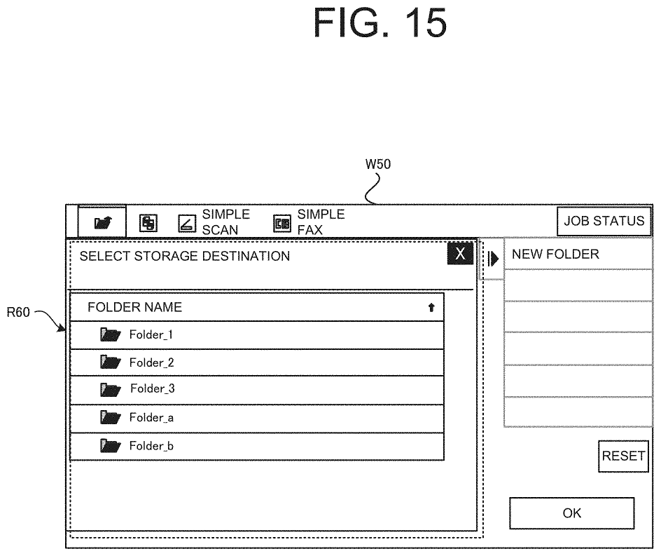

FIG. 15 is a diagram illustrating a configuration example of a file path setting screen W50 for setting a file path to an external storage device.

The file path setting screen W50 includes a file path setting area R60. The file path setting area R60 displays, in a selectable manner, a folder structure of an external storage device in which image data is to be stored in a scan save function or a filing function-related job. The user can set a storage destination for the image data by selecting a desired folder from among folders thus displayed. The user may alternatively set the storage destination for the image data by directly entering a file path representing a storage destination for the image data. In this case, the controller 11 determines that a setting value related to the file path representing the storage destination for the image data meets the definition of the specific setting value. The controller 11 performs a control to restrict the setting value related to this file path from being stored in a setting value file.

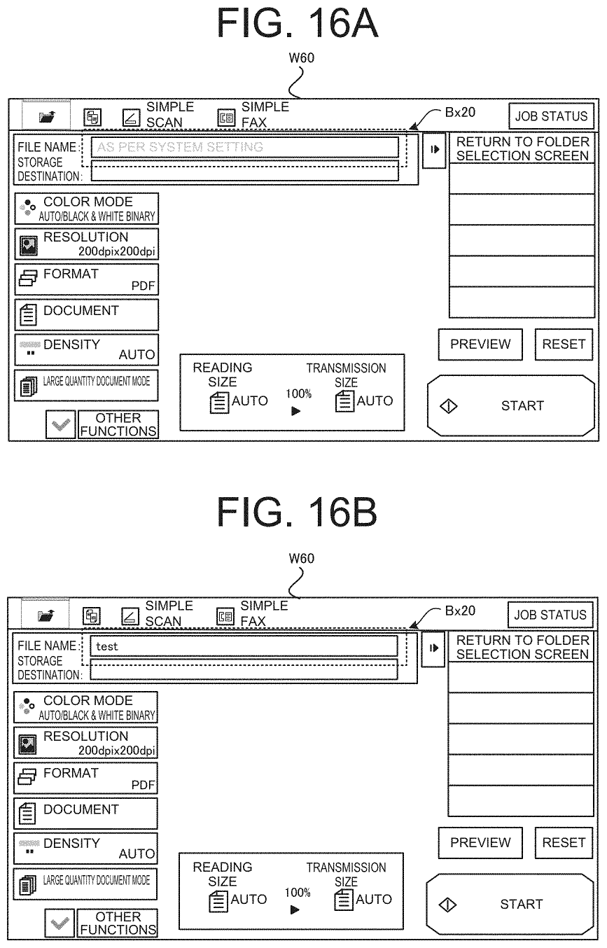

FIGS. 16A and 16B are diagrams each illustrating an exception of an automatic file name generation-related setting value, which is the specific setting value. FIG. 16A shows a configuration example of a job setting screen W60 for a filing function-related scan save job. The job setting screen W60 includes a file name entry box Bx20. If the file name entry box Bx20 is blank with an automatic file name generation function enabled, the controller 11 automatically generates a file name by including, for example, a date as identification information for the execution of the job. In this case, the controller 11 determines that a setting value related to the automatically generated file name including the identification information such as the date meets the definition of the specific setting value. The controller 11 performs a control to restrict the setting value related to this file name from being stored in a setting value file.

If a file name (for example, test) is manually entered in the file name entry box Bx20 as shown in FIG. 16B, the controller 11 determines that a setting value related to the entered file name meets the definition of the specific setting value but is to be handled as an exception, because the setting value does not include identification information such as a date. In this case, the controller 11 stores, in a setting value file, the setting value related to the manually entered file name.

As described above, according to the second embodiment, the specific setting value is a job operation-related setting value including a setting value that is not reusable for job execution. Since the second embodiment has a configuration in which the storing of setting values is partially restricted when the setting values include such a specific setting value, an image processing apparatus and the like can be provided that makes it possible to reduce the burden of manually changing a setting and to further improve the convenience of the use of history information, when setting history is reused.

Furthermore, the configuration of the second embodiment, in which not of the setting values are stored as the setting history (setting value file), makes it possible to prevent the finite storage capacity within the multifunction peripheral 10 from being needlessly consumed.

### 3. Third Embodiment

According to the first embodiment and the second embodiment, a job execution-related setting value is restricted from being stored if the setting value meets the definition of the specific setting value. According to a third embodiment, a job execution-related setting value is stored even if the setting value meets the definition of the specific setting value, provided that the setting value satisfies any of predetermined conditions.

3.1. Functional Configuration

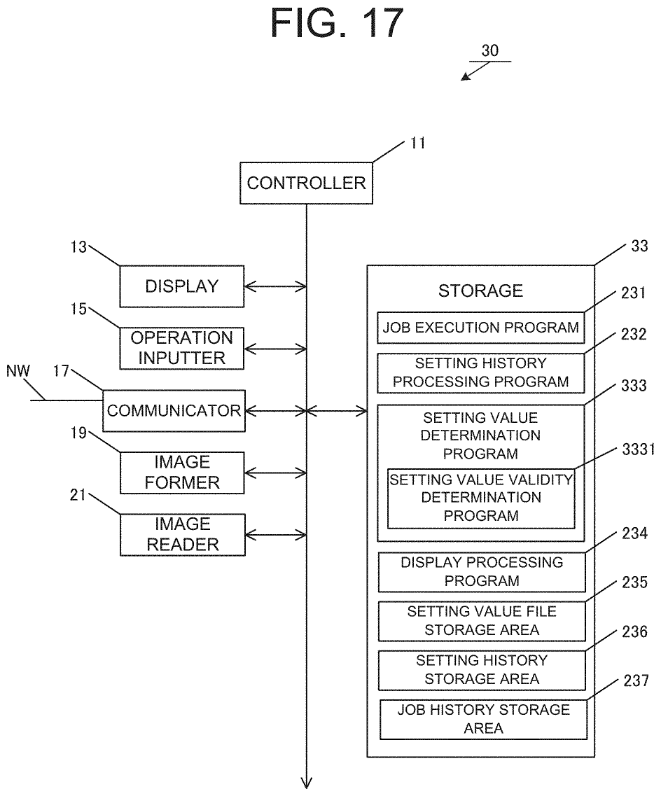

FIG. 17 is a functional configuration diagram of a multifunction peripheral 30 according to the third embodiment. The multifunction peripheral 30 according to the third embodiment may have substantially the same functional configuration as the multifunction peripheral 10 according to the first embodiment. The same elements of configuration are therefore labeled with the same reference signs, and description thereof will be omitted.

The multifunction peripheral 30 includes a storage 33 in place of the storage 23 of the multifunction peripheral 10. In the third embodiment, the storage 33 stores therein a job execution program 231, a setting history processing program 232, a setting value determination program 333, and a display processing program 234. In the storage 33, a setting value file storage area 235, a setting history storage area 236, and a job history storage area 237 are reserved.

The setting value determination program 333 has the configuration of the setting value determination program 233 and further includes a setting value validity determination program 3331. The controller 11 reads the setting value validity determination program 3331 in the examination of each of the read job execution-related setting values against the specific setting value according to, for example, Step S3020 in FIG. 7, Step S3050 and Step S3060 in FIG. 11, and Step S3070 to Step S3130 in FIG. 14.

The controller 11 that has read the setting value validity determination program 3331 determines, as setting value validity determination processing, whether or not the job execution-related setting value meets the definition of the specific setting value and whether or not the job execution-related setting value satisfies, for example, any of the following predetermined conditions (1) to (3), and thus determines whether or not to restrict the setting value from being stored.

(1) The setting value indicates an identification code set by a login user having administrative rights.
(2) The setting value is related to paper selection and indicates the number of sheets to be printed on that is less than a predetermined number.
(3) The setting value indicates a specific external storage device file path.

(1) The Setting Value Indicates an Identification Code Set by a Login User Having Administrative Rights.

Since the identification code has been set by a login user having administrative rights, storing this identification code as the setting history (setting value file) is unlikely to cause security problems.

(2) The Setting Value is Related to Paper Selection and Indicates the Number of Sheets to be Printed on that is Less Than a Predetermined Number.

In a case where the number of printable sheets is “10”, and “9” is set as a setting value indicating the number of sheets to be printed on, for example, the setting value indicating the number of sheets to be printed on is stored. By contrast, in a case where “10” or a larger number is set as a setting value indicating the number of sheets to be printed on, the setting value indicating the number of sheets to be printed on is restricted from being stored. This configuration makes it possible to prevent unintended output of a large number of printed sheets due to, for example, a number entry error for a copy job for copying a small number of sheets, while ensuring the user's convenience in reusing the setting history.

(3) The Setting Value Indicates a Specific External Storage Device File Path.

A setting value related to information about, for example, a portable storage device like a USB memory device, such as memory manufacturer, memory type, or storage capacity, is likely to vary depending on user. In a case where a setting value indicates the use of a USB memory device as an external storage device, therefore, the setting value is restricted from being stored. By contrast, a setting value related to information about a fixedly installed external storage device like network attached storage (NAS), such as network address, memory manufacturer, memory type, or storage capacity, is expected to be changed less often. In a case where a setting value indicates the use of NAS as an external storage device, therefore, a practice not to restrict the setting value from being stored is possible.

The predetermined conditions (1) to (3) shown above are merely examples, and the predetermined conditions according to the present embodiment are not limited to the description of the predetermined conditions (1) to (3).

3.2. Flow of Processing

Processing according to the third embodiment may be performed in the same manner as in the first embodiment or the second embodiment. In this case, the setting value validity determination processing may be performed in conjunction with the processing according to Step S3020 in FIG. 7 according to the first embodiment, Step S3050 and Step S3060 in FIG. 11, and Step S3070 to Step S3130 in FIG. 14 according to the second embodiment.

3.3. Operation Example

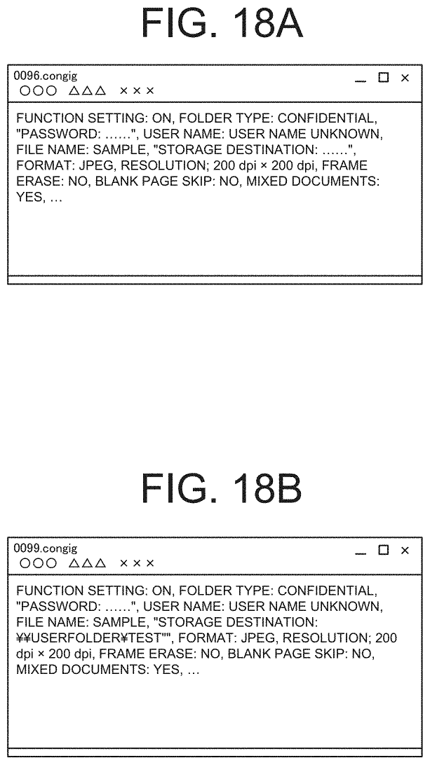

FIGS. 18A and 18B are diagrams each illustrating an operation example according to the third embodiment. FIG. 18A shows an example of a data configuration of a setting value file in a case where a USB memory device is set as an external storage device. FIG. 18B shows an example of a data configuration of a setting value file in a case where NAS is set as an external storage device.

As shown in FIGS. 18A and 18B, a password, which is an identification code, meets the definition of the specific setting value, and is therefore restricted from being stored.

In a case where a USB memory device is set as an external storage device, a file path to the USB memory device set as “storage destination” is restricted from being stored as shown in FIG. 18A. By contrast, in a case where NAS is set as an external storage device, a file path “¥¥USERFOLDER¥TEST” thereto set as “storage destination” is stored as shown in FIG. 18B.

The third embodiment allows even a job execution-related setting value that meets the definition of the specific setting value to be stored as setting history, provided that the setting value indicates a setting that satisfies any of the predetermined conditions. According to the third embodiment, therefore, an image processing apparatus and the like can be provided that offers more convenient and flexible use of history information to the user in addition to the effects of the first embodiment and the second embodiment.

The present disclosure is not limited to the embodiments described above, and various modifications may be made thereto. That is, the technical scope of the present disclosure also includes embodiments that may be obtained by combining technical measures that are modified as appropriate without departing from the gist of the present disclosure.

Although some of the foregoing embodiments are described separately for convenience of explanation, it is needless to say that such embodiments may be combined and implemented within a technically allowable range.

The program(s) that operates on each of the devices in the foregoing embodiments is a program that controls the CPU or the like (program that causes a computer to function) so as to implement the functions according to the foregoing embodiments. The information handled by these devices is temporarily accumulated in a temporary storage device (for example, RAM) during the processing, is then stored in various storage devices such as ROM and an HDD, and is read, corrected, and written by the CPU as needed.

Here, a recording medium that stores the program may be, for example, any of a semiconductor medium (for example, ROM and a non-volatile memory card), an optical recording medium/magneto-optical recording medium (for example, a digital versatile disc (DVD), a magneto optical disk (MO), a Mini Disc (MD), a compact disc (CD), and a Blu-ray (registered trademark) Disc (BD)), and a magnetic recording medium (for example, a magnetic tape and a flexible disc). Furthermore, not only are the functions of the foregoing embodiments implemented through execution of the loaded program, but the functions of the present disclosure may also be implemented through processing performed in cooperation with, for example, an operating system or other application programs on the basis of instructions of the program.

For market distribution, the program may be stored and distributed in a portable recording medium or transferred to a server computer connected via a network such as the Internet. In this case, a storage device of the server computer is obviously included in the present disclosure.

What is claimed is:

1. An image processing apparatus comprising:
a job executor that executes a job related to image processing;
a storage that stores therein a setting value related to the execution of the job as setting history; and
a controller that controls the storing of the setting value into the storage, wherein
the controller restricts the setting value from being stored if the setting value meets definition of a specific setting value.

2. The image processing apparatus according to claim 1, wherein the controller includes a determiner that determines whether or not the setting value meets the definition of the specific setting value.

3. The image processing apparatus according to claim 2, wherein the specific setting value is a security-related setting value, and the determiner determines whether or not the setting value meets definition of the security-related setting value.

4. The image processing apparatus according to claim 3, wherein the security-related setting value includes an identification code for accessing access-controlled information.

5. The image processing apparatus according to claim 2, wherein the specific setting value is a job operation-related setting value, and the determiner determines whether or not the setting value meets definition of the job operation-related setting value.

6. The image processing apparatus according to claim 5, wherein the job operation-related setting value includes a setting value that is not reusable for job execution using the setting history.

7. The image processing apparatus according to claim 6, wherein the setting value that is not reusable for job execution includes a preview image edit-related setting value or an interrupt job-related setting value.

8. The image processing apparatus according to claim 6, wherein the setting value that is not reusable for job execution includes a setting value related to paper selection, unauthorized printing prevention, developer saving, automatic file name generation, document reading, external storage device file path, or digital signature or encryption.

9. The image processing apparatus according to claim 1, wherein
the setting history includes a plurality of the setting values, and
the controller stores, in the storage, the setting values other than the setting value that meets the definition of the specific setting value.

10. The image processing apparatus according to claim 1, wherein the controller stores the setting value even if the setting value meets the definition of the specific setting value, provided that the setting value satisfies a predetermined condition.

11. A method for storing setting history, the method comprising:
executing a job related to image processing;
storing a setting value related to the execution of the job as setting history; and
controlling the storing of the setting value in the storing, wherein
in the controlling, the setting value is restricted from being stored if the setting value meets definition of a specific setting value.
